(19) United States
(12) Patent Application Publication
(10) Pub. No.: US 2007/0237614 A1
(43) Pub. Date: Oct. 11, 2007

(54) Ramp apparatus for use with an automotive vehicle

(76) Inventor: Robert Allen Johnson, Princeton, MN (US)

Correspondence Address: Roger L. Belfay, 829 Tuscarora Avenue, Saint Paul, MN, 55102, US

(21) Appl. No.: 11/697,177

(22) Filed: Apr. 5, 2007

Related U.S. Application Data
(60) Provisional application No. 60/789,820, filed on Apr. 6, 2006.

(51) Int. Cl. B60P 1/04

(52) U.S. Cl. 414/467

(57) ABSTRACT

The present invention is a ramp used to access the bed of an automotive vehicle. In particular, the ramp is positioned within the bed of a pick-up truck without interfering with the use of the bed of the pickup truck.

### CROSS REFERENCE TO RELATED APPLICATIONS

The application listed below is the only application related to this application. This application claims benefit of the earlier filing date under 35 USC 119(e) of provisional application number 60/789,820 filed on Apr. 6, 2006.

### STATEMENT REGARDING FEDERAL SPONSORSHIP

No invention claimed in this application was made under Federally sponsored research or development.

### BACKGROUND OF INVENTION

Facilitation of the loading and unloading of equipment and heavy loads from vehicles has been the objective much inventive effort. Among those efforts is a class of inventions which includes storable ramps. These ramps are generally storable on the automotive vehicle which will ultimately carry both the load and the ramp. An object of all these inventions is to provide the longest possible ramp to minimize the incline to be traversed while providing for on-board storage of the ramp. A further object of these inventions is the ease and simplicity of deployment of the ramp for use and storage of the ramp for transport.

U.S. Pat. No. 5,468,114 to Hickerson, U.S. Pat. No. 5,312,149 to Boone, and U.S. Pat. No. 3,642,156 to Stenson are typical of a class of inventions which achieve these objectives by incorporating the vehicle's tailgate or a replacement of said tailgate into the ramp by affixing the tailgate to the ramp and providing means for latching the total assembly in place for transport.

U.S. Pat. No. 5,795,125 to Walkden, U.S. Pat. No. 4,624,619 to Uher, U.S. Pat. No. 4,900,217 to Nelson, U.S. Pat. No. 5,257,894 to Grant, and U.S. Pat. No. 4,601,632 to Agee are typical of a class of inventions which achieve these objectives by providing a two part ramp mechanism wherein the two parts of the ramp are pivotally but not slidably connected to permit one section to rest on the vehicle's tailgate while the second section completes the pathway to the ground.

U.S. Pat. No. 3,977,545 to Lloyd and U.S. Pat. No. 2,370,427 to Sherry are typical of a class of inventions which pivotally attach a ramp to a housing in which the housing and pivotal attachment point remain inboard of the tailgate.

U.S. Pat. No. 6,042,923 to Lewis and U.S. Pat. No. 3,870,170 to Noble et al. are typical of a class of inventions which achieve these objectives by providing a two part ramp mechanism wherein the two parts of the ramp are pivotally connected and slidable within the housing without permitting the two sections to telescope.

A review of the above classes of inventions reveals that the present invention provides for ease of storage and deployment, requires no modifications or replacement of a pickup's tailgate while providing for a ramp which exhibits reduced incline because the overall length of the ramp provided by the present invention is not limited by the overall length of the bed of the vehicle on which it is installed.

### BRIEF SUMMARY OF THE INVENTION

The present invention is a ramp used to access the bed of an automotive vehicle. In particular, the ramp is positioned within the bed of a pick-up truck without interfering with the use of the bed of the pickup truck.

The present invention includes a ramp construction having a left ramp member and a right ramp member pivotally attached to a left tailgate support member and a right tailgate support member. The left tailgate support member is pivotally connected to the housing and the right tailgate support member is pivotally connected to the housing. It will be understood that a single ramp member extending the combined width of left ramp member and ramp member could be used and remain within the scope of the present invention. It will be further understood that three or more ramp members could be combined to extend the combined width of left ramp member and right ramp member. It is also to be understood that the aforementioned single ramp, left ramp, right ramp, and indeed any number of ramps may be of unequal widths and need not individually or in total occupy the full width available within the pick-up truck bed.

The pivotal connection between the left ramp member and the left tailgate support member as well as the pivotal connection between the right ramp member and the right tailgate support member is a bolt held in place by a cotter pin. The type of pivotal connection is not important and any type of pivoting connection can be used and remain within the scope of the present invention.

### BRIEF DESCRIPTION OF THE DRAWINGS

FIG. 1 is a perspective view of the ramp construction.

FIG. 2 is a side elevation of FIG. 1.

FIG. 3 is a detail view of the pivotal connection.

FIG. 4 is a perspective view of the invention, in use, in the storage position.

FIG. 5 is a perspective view of the invention, in use, in the extended position.

FIG. 6 is a top view of a first embodiment of the invention.

FIG. 7 is a side view of FIG. 6.

FIG. 8 is a top view of a second embodiment of the invention.

FIG. 9 is a side view of FIG. 8.

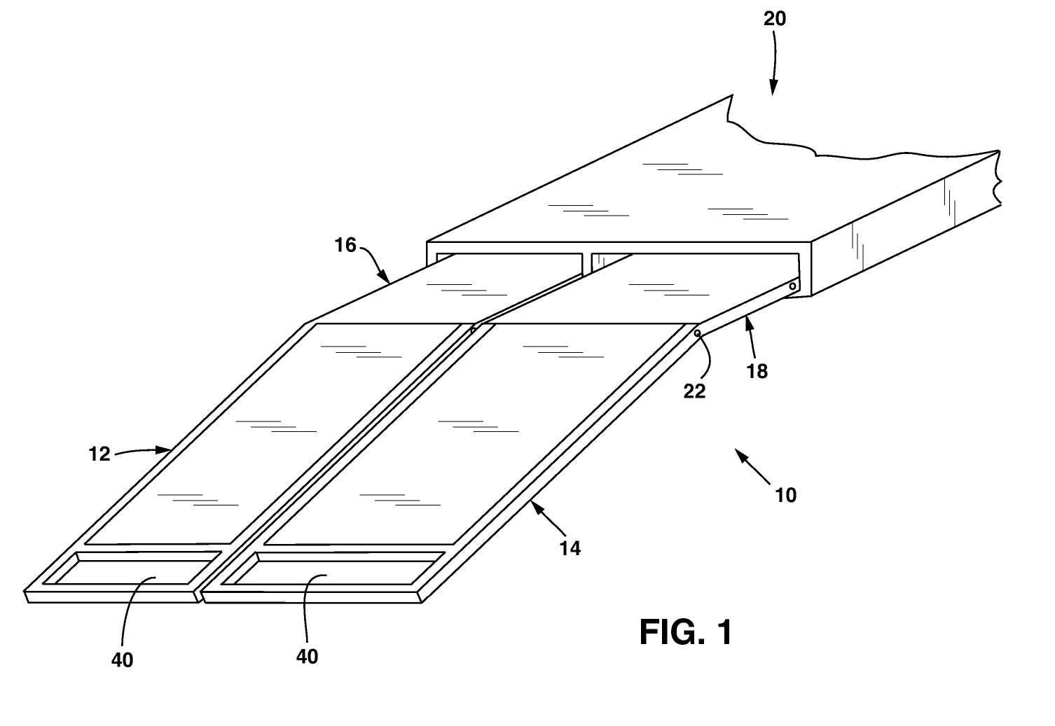

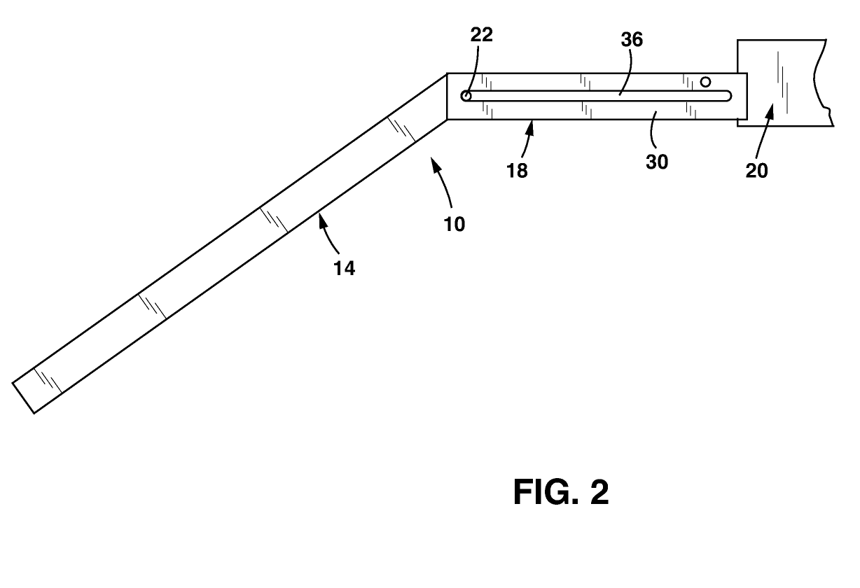

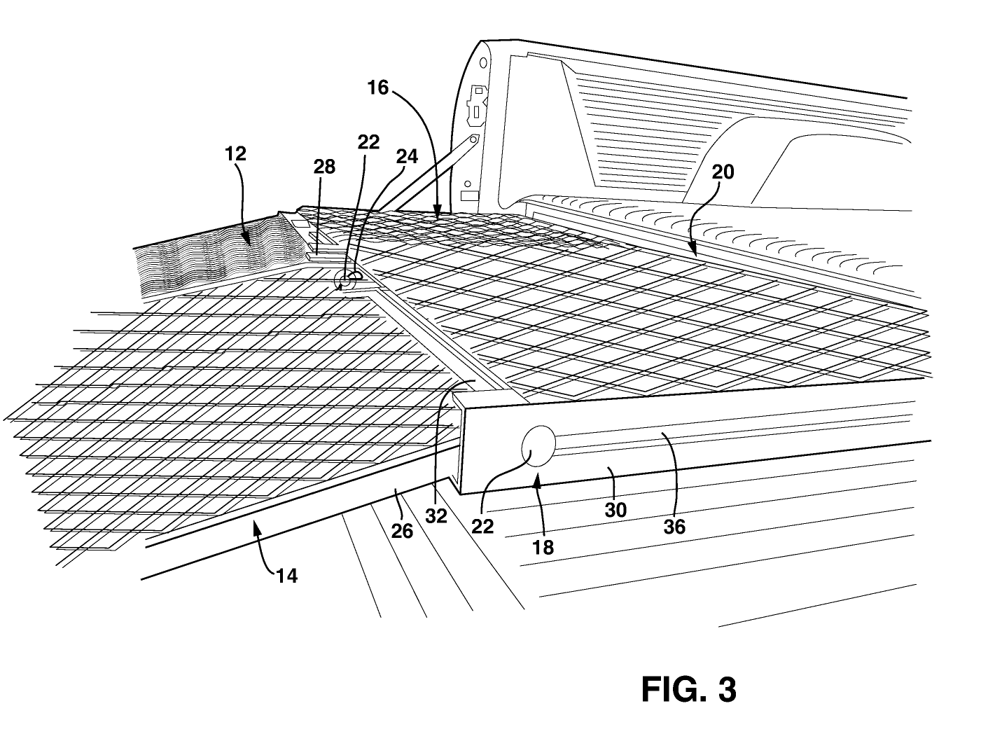

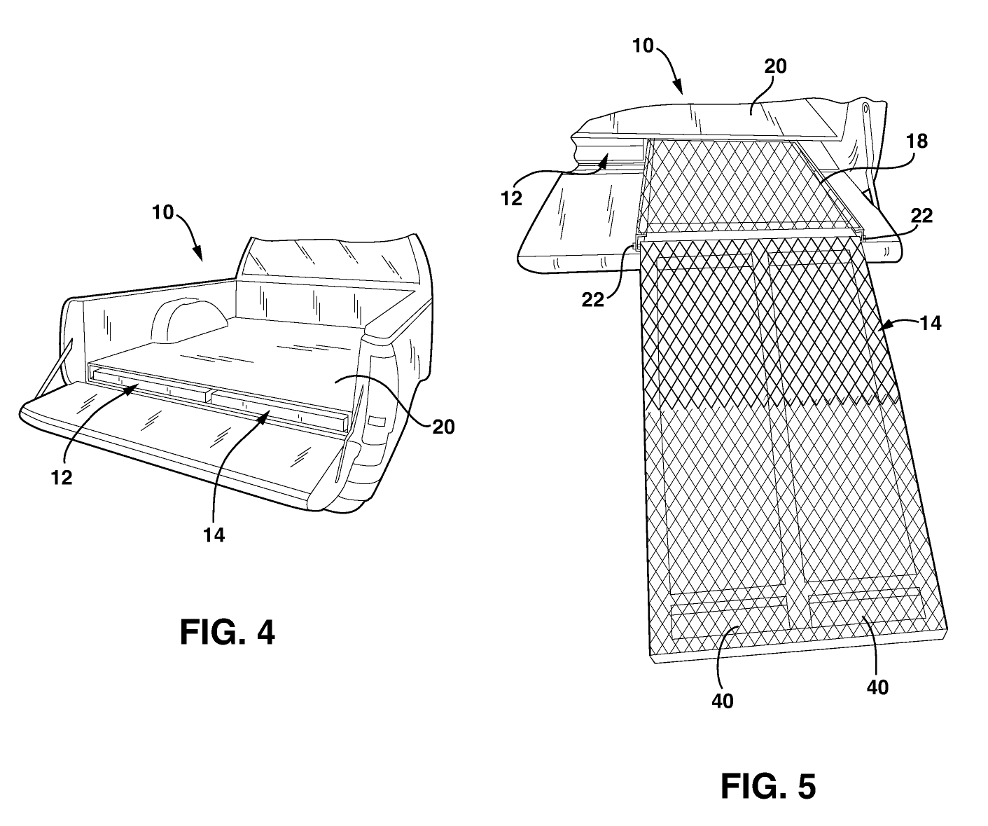

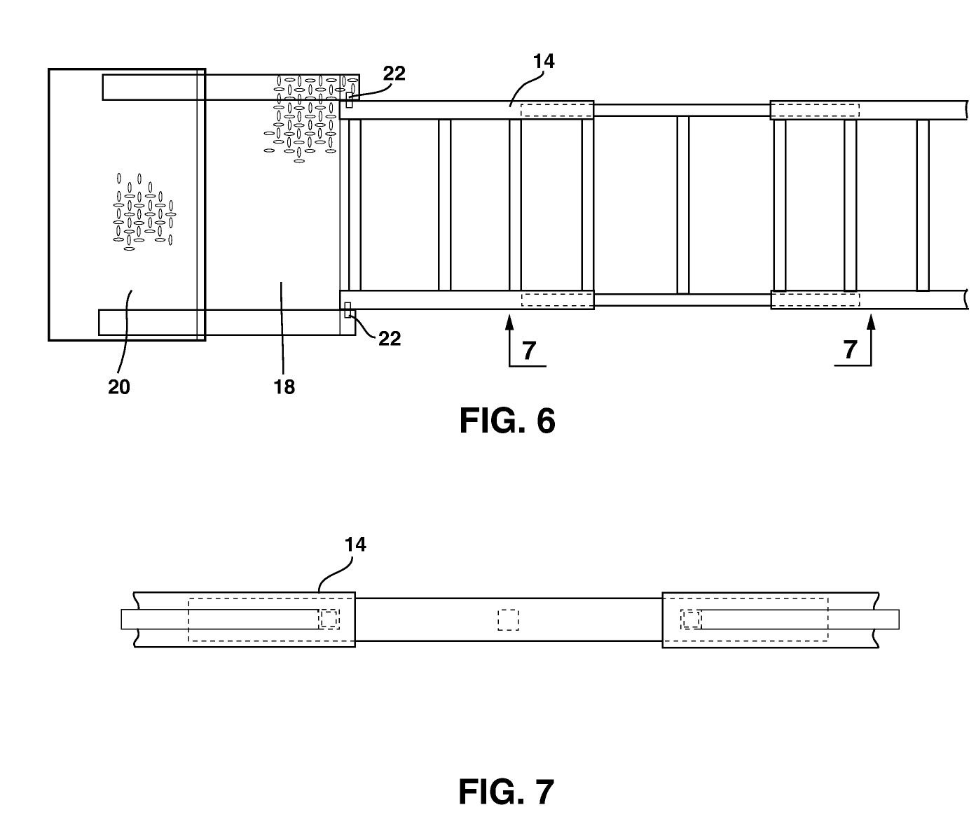

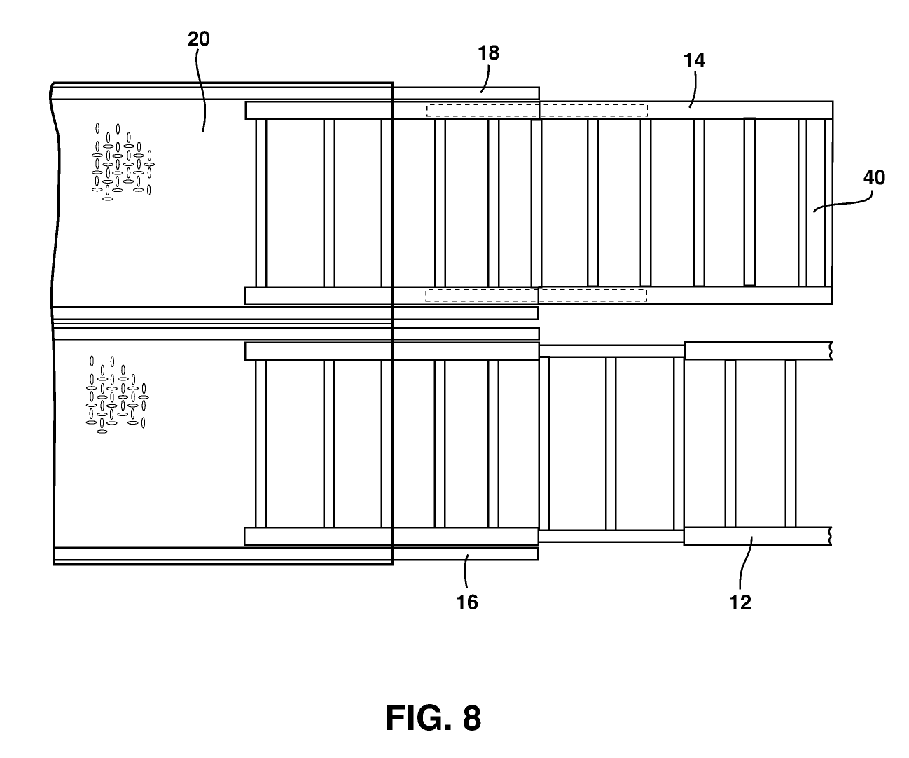

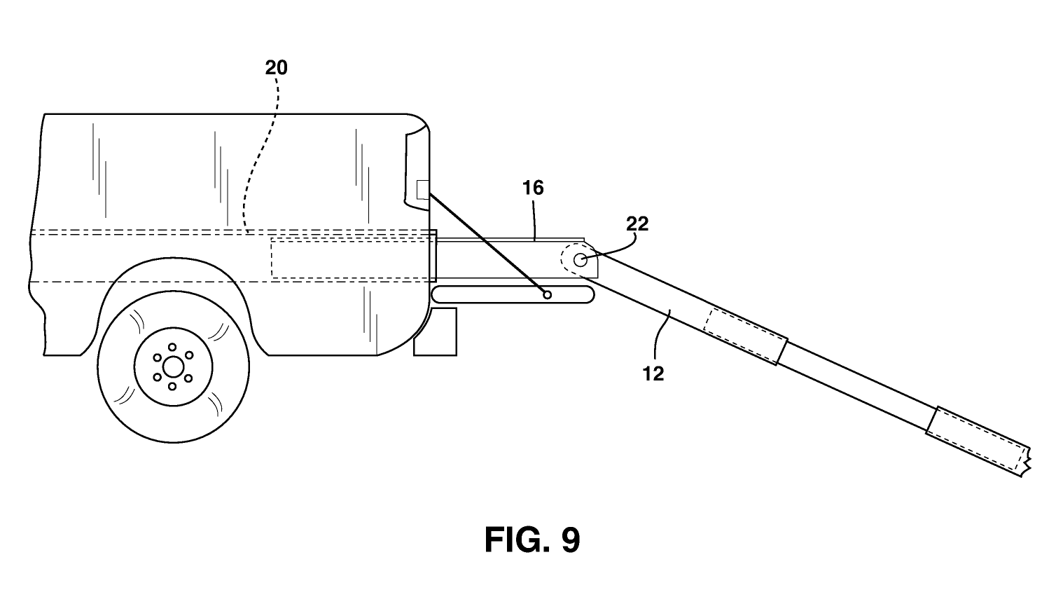

I claim:

1) A ramp apparatus for use with an automotive vehicle comprising:
a) a housing for positioning within an automotive vehicle;
b) a tailgate support member pivotally connected within the housing, and slidable within and throughout the length of the housing; and
c) a ramp member pivotally connected to the tailgate support member and slidable within the tailgate support member throughout the length of the tailgate support member such that the ramp member slides through the length of the tailgate support member and slides within the length of the housing.

2) The ramp apparatus of claim of claim 1 further comprising: one or more additional tailgate support members each tailgate support member with one ramp member pivotally connected to the tailgate support member and slidable within the tailgate support member throughout the length of the tailgate support member such that the ramp member slides through the length of the tailgate support member and slides within the length of the housing.

3) The ramp apparatus of claim 1 further comprising one or more additional tailgate support members each tailgate support member with one or more ramp members pivotally connected to the tailgate support member and slidable within the tailgate support member throughout the length of the tailgate support member such that the ramp member slides through the length of the tailgate support member and slides within the length of the housing.

4) The ramp apparatus of claim 1 wherein the ramp member further comprises a hand hold.

5) The ramp apparatus of claim 1 wherein the ramp member further comprises one or more telescoping extensions.

6) A ramp apparatus for use with an automotive vehicle comprising:
a) a housing for positioning within an automotive vehicle;
b) a tailgate support member slidably connected within the housing, and slidable within and throughout the length of the housing; and
c) a ramp member pivotally connected to the tailgate support member and slidable within the tailgate support member throughout the length of the tailgate support member such that the ramp member slid through the length of the tailgate support member slides within the length of the housing.

7) The ramp apparatus of claim of claim 6 further comprising: one or more additional tailgate support members each tailgate support member with a ramp member pivotally connected to the tailgate support member and slidable within the tailgate support member throughout the length of the tailgate support member such that the ramp member slid through the length of the tailgate support member slides within the length of the housing.

8) The ramp apparatus of claim 6 further comprising: one or more additional tailgate support members each tailgate support member with one or more a ramp members pivotally connected to the tailgate support member and slidable within the tailgate support member throughout the length of the tailgate support member such that the ramp member slides through the length of the tailgate support member and slides within the length of the housing.

9) The ramp apparatus of claim 6 wherein the ramp member further comprises a hand hold.

10) The ramp apparatus of claim 6 wherein the ramp member further comprises one or more telescoping extensions.
